(19) United States
(12) Patent Application Publication
(10) Pub. No.: US 2019/0006926 A1
(43) Pub. Date: Jan. 3, 2019

(54) LINEAR VIBRATION MOTOR

(71) Applicant: Goertek Inc., Shandong (CN)

(72) Inventors: Yueguang Zhu, Shandong (CN); Weiye Zang, Shandong (CN); Bin Wang, Shandong (CN); Chunfa Liu, Shandong (CN)

(21) Appl. No.: 15/746,737

(22) PCT Filed: Dec. 19, 2016
(86) PCT No.: PCT/CN2016/110777

§ 371 Date: Jan. 22, 2018

(30) Foreign Application Priority Data
Sep. 30, 2016 (CN) 201610872750.7

(51) Int. Cl. H02K 33/02; H02K 33/18; H02K 5/24

(52) U.S. Cl. CPC H02K 33/02; H02K 2211/03; H02K 5/24; H02K 33/18

(57) ABSTRACT

A linear vibration motor is disclosed. The motor comprises: a stator component comprising a shell, a pole core and a coil component, wherein the shell has a cavity body therein, the pole core is disposed on a bottom and comprises a magnetic pole at the middle of the pole core along a vibration direction and protruding out of the outer surface of the pole core, the coil component is divided into a first coil and a second coil by the magnetic pole, and current directions of the first and second coils are opposite; a vibrator component comprising a permanent magnet surrounding the coil component and a counter weight part on the permanent magnet, the permanent magnet being axially magnetized; and an elastic element, by which the vibrator component is suspended in the cavity body, and which is configured for returning the vibrator component to an initial position.

### CROSS REFERENCE TO RELATED APPLICATIONS

This application is a national stage application, filed under 35 U.S.C. § 371, of International Application No. PCT/CN2016/110777, filed Dec. 19, 2016, which claims priority to Chinese Application No. 201610872750.7, filed Sep. 30, 2016, the contents of both of which as are hereby incorporated by reference in their entirety.

### BACKGROUND

### Technical Field

The present invention relates to the technical field of vibration motors, and more particularly, relates to a linear vibration motor.

### Description of Related Art

An existing linear vibration motor generally comprises a vibrator, a stator and an elastic sheet. The vibrator comprises a magnet, a counter weight part and washers. The stator comprises a shell, an iron core and a coil component. The coil component sleeves the periphery of the iron core. The washers and the iron core play a role of concentrating magnetic lines to improve a magnetic field intensity. During work, the magnetic lines penetrate through the coil component to generate a Lorentz force so as to drive the vibrator to vibrate. The existing vibration motor has the technical problems of a small drive force and slow vibration response.

### BRIEF SUMMARY

An object of the present invention is to provide a new technical solution of a linear vibration motor.

According to a first aspect of the present invention, there is provided a linear vibration motor. The motor comprises:

a stator component, wherein the stator component comprises a shell, a pole core and a coil component, the shell has a cavity body therein, the shell comprises a top and a bottom opposite to the top, the pole core and the coil component are located in the cavity body, the pole core is disposed on the bottom, the pole core comprises a magnetic pole located in the middle of the pole core along a vibration direction and protruding out of the outer surface of the pole core, the coil component sleeves the outer surface of the pole core, the coil component is divided into a first coil and a second coil by the magnetic pole, and a current direction of the first coil is opposite to that of the second coil;

a vibrator component, wherein the vibrator component comprises a permanent magnet disposed by surrounding the coil component and a counter weight part disposed on the permanent magnet, wherein the permanent magnet is axially magnetized, and after the coil component is powered on, a magnetic force is formed between the magnetic pole and the permanent magnet; and

an elastic element, wherein the vibrator component is suspended in the cavity body by the elastic element, and the elastic element is configured for returning the vibrator component to an initial position.

Optionally, the shell comprises an upper shell and a lower shell which are connected together, the top is located on the upper shell and the bottom is located on the lower shell.

Optionally, one end of the pole core and the bottom are connected together, and the other end of the pole core and the top are connected together.

Optionally, the elastic element is a spiral elastic sheet, and the spiral elastic sheet is located on one side of the vibrator component close to the top or located on one side of the vibrator component close to the bottom.

Optionally, the upper shell and the lower shell are made of a magnetically conductive material.

Optionally, a material of the upper shell and the lower shell is iron, cobalt or nickel.

Optionally, at least one of a position of the bottom corresponding to the counter weight part and a position of the top corresponding to the counter weight part is provided with a damping part.

Optionally, a magnetic path system comprises the coil component, the pole core, the permanent magnet and washers, the coil component sleeves the outer side of the pole core, the permanent magnet is disposed by surrounding the coil component, a clearance exists between the permanent magnet and the coil component, the washers are located on upper and lower ends of the permanent magnet, and the magnetic path system is configured to be square or round.

Optionally, a first end and a second end which are disposed oppositely are arranged in an axial direction of the permanent magnet, a first washer is disposed at the first end and a second washer is disposed at the second end.

Optionally, an FPCB is provided on the bottom, the coil component is electrically connected to an external circuit by the FPCB, and the counter weight part is further provided with a makeway groove for making room for the FPCB.

The inventors of the present invention have found that in the prior art, since vibration of the vibration motor merely depends on a Lorentz force, there exists the technical problems of a small drive force and slow vibration response. Thus, the technical task to be realized by the present invention or the technical problem to be solved is not contemplated or predicted by those skilled in the art, so the present invention is a new technical solution.

The linear vibration motor provided by the present invention is provided with two coils, which are opposite in current direction and are separated by the magnetic pole located at the middle of the pole core. A disposing manner of the two coils improves a drive force of the coil component, such that the linear vibration motor is faster in vibration response.

In addition, a magnetic force is formed between the pole core and the permanent magnet, and a direction of the magnetic force is the same as a moving direction of the vibrator component, such that the drive force of the vibrator component is further improved.

In addition, the magnetic force between the pole core and the permanent magnet can effectively reduce f₀ (the lowest resonant frequency) of the linear vibration motor, thereby improving the vibration sense experience.

Other features and advantages of the present invention will become clear according to the detailed description of exemplary embodiments of the present invention with reference to the accompanying drawings.

### BRIEF DESCRIPTION OF THE FIGURES

The figures incorporated in the description and forming a part of the description illustrate the embodiments of the present invention and are used to explain the principle of the present invention along therewith.

FIG. 1 is an exploded view of a linear vibration motor of an embodiment of the present invention.

FIG. 2 is a sectional view of a linear vibration motor of an embodiment of the present invention.

FIG. 3 is a sectional view of a linear vibration motor of an embodiment of the present invention from another angle.

FIG. 4 is a structural schematic diagram of a pole core of an embodiment the present invention.

FIG. 5 is a sectional view of another linear vibration motor of an embodiment of the present invention.

FIG. 6 is a sectional view of a round linear vibration motor of an embodiment of the present invention.

FIG. 7 is a structural schematic diagram of a square magnetic path system of an embodiment of the present invention.

### REFERENCE SIGNS IN THE FIGURES

11: upper shell; 12: spiral elastic sheet; 13: annular elastic gasket; 14: tungsten steel block; 15: first washer; 16: first coil; 17: annular magnet; 18: pole core; 19: second washer; 20: FPCB; 21: flaky damper; 22: second coil; 23: magnetic pole; 24: makeway groove; 25: lower shell.

### DETAILED DESCRIPTION OF VARIOUS EMBODIMENTS

Various exemplary embodiments of the present invention will be described in detail with reference to the accompanying drawings. It should be noted that unless stated specifically otherwise, the relative arrangement of the components and steps illustrated in these embodiments, the numeral expressions and the values do not limit the scope of the present invention.

The description of at least one exemplary embodiment of the present invention is actually merely illustrative rather than limiting the present invention and the application or use thereof.

Technologies, methods and devices known to those skilled in the art may not be described in detail, but when appropriate, the technologies, methods and devices shall be regarded as a part of the description.

Any particular value in all examples illustrated and described here shall be construed as merely illustrative rather than limiting. Thus, other examples of the exemplary embodiments may have different values.

It should be noted that similar signs and letters represent similar items in the following figures, and thus, once a certain item is defined in a figure, there is no need to further describe the same in the following figures.

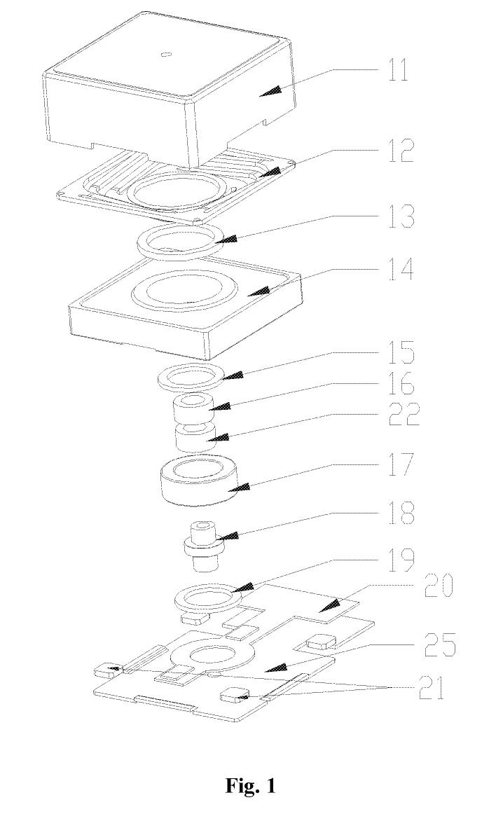

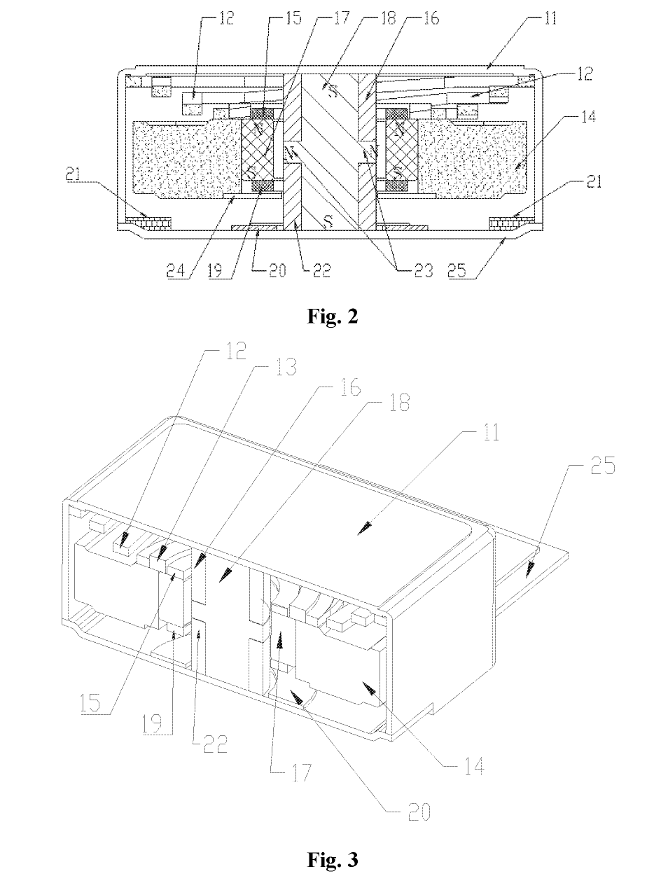

The present invention provides a linear vibration motor. As shown in FIGS. 1 and 2, the linear vibration motor comprises a stator component, a vibrator component and an elastic element. The stator component comprises a shell, a pole core 18 and a coil component. The shell has a cavity body therein. The shell comprises a top and a bottom opposite to the top. The pole core 18 and the coil component are located in the cavity body. The pole core 18 is disposed on the bottom. Preferably, the pole core 18 is disposed at the middle of the bottom, and in this way, a space in the cavity body can be fully used.

In one example, as shown in FIGS. 1 and 2, in order to conveniently detach and mount the linear vibration motor, the shell is configured to comprise an upper shell 11 and a lower shell 25. The upper shell 11 and the lower shell 25 are connected together. For example, the two are connected to each other by adopting a buckling manner. Alternatively, for example, the two are connected to each other by adopting a binder. A cavity body is formed in the upper shell 11 and the lower shell 25. The top is located on the upper shell 11, and the bottom is located on the lower shell 25. A flexible printed circuit board (FPCB) 20 is provided on the bottom. The coil component is electrically connected to an external circuit by the FPCB 20. Of course, a cable may also be adopted to connect the external circuit to the lead of the coil. In addition, in order to avoid damages to the FPCB 20 when the vibrator component, particularly a counter weight part, collides against the FPCB 20 during vibration, the weight counter part is further provided with a makeway groove 24 for making room for the FPCB 20.

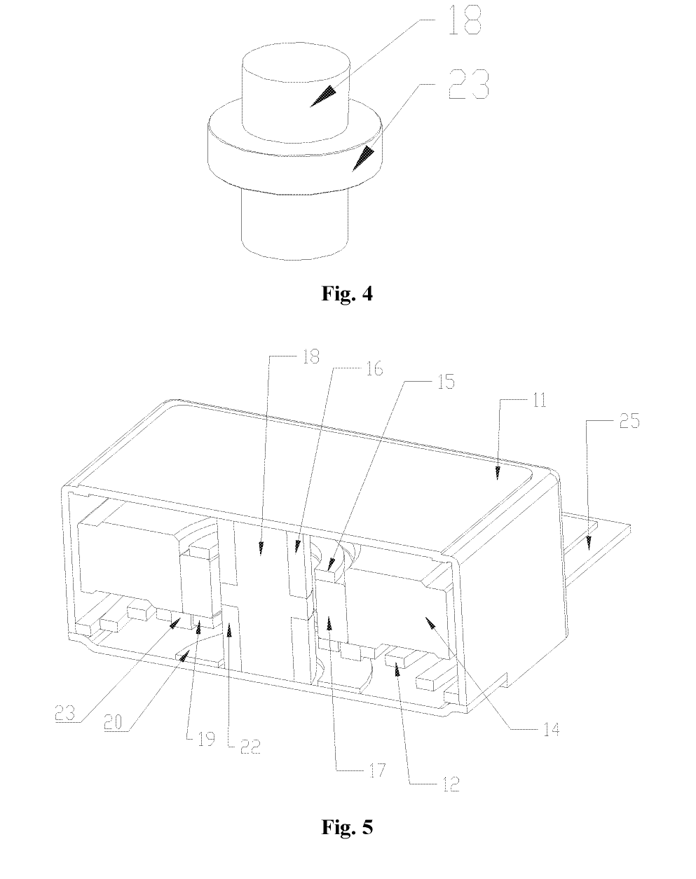

As shown in FIGS. 2 and 3, the pole core 18 is disposed in the middle of the lower shell 25. For example, the pole core 18 can be fixed in the middle of the lower shell 25 by an adhering manner. The pole core 18 is used to concentrate electromagnetic fields generated by the coil component. As shown in FIG. 4, the pole core 18 comprises a magnetic pole 23 located at the middle of the pole core 18 along a vibration direction and protruding out of the outer surface of the pole core 18. A shape of the pole core 18 is similar to a cross. The magnetic pole 23 is used to overflow the electromagnetic fields when the coil component is powered on. The vibration direction is a direction when the vibrator component works. The axial directions of the pole core 18 and the coil component are parallel with the vibration direction.

As shown in FIGS. 2 and 3, the coil component sleeves the outer surface of the pole core 18. The coil component generates the electromagnetic fields in response to electric signals from the external circuit. The coil component is divided into a first coil 16 and a second coil 22 by the magnetic pole 23. A current direction of the first coil 16 is opposite to that of the second coil 22. In one example, the first coil 16 and the second coil 22 are formed by winding the same wire. For example, the first coil 16 is formed by winding clockwise, and the second coil 22 is formed by winding counterclockwise (when seen from the top). In such a case, the first coil 16 and the second coil 22 are serially connected. The two coils share one pair of leads. For example, the first coil 16 and the second coil 22 can also be formed by winding respectively as long as the two coils are opposite in winding direction. The leads of the first coil 16 and the second coil 22 are respectively connected to the FPCB 20. Preferably, the first coil 16 and the second coil 22 are equal in turn number. Due to such a disposing manner, the electromagnetic fields generated by the two coils can be equal in intensity, and magnetic field forces that the two coils are subjected to are equal.

As shown in FIGS. 1 and 2, the vibrator component comprises a washer, a permanent magnet and a counter weight part disposed by surrounding the permanent magnet. The counter weight part is used for increasing inertia of the vibrator component to increase a vibration amplitude of the vibration motor. The counter weight part may be but is not limited to a tungsten steel block 14.

The permanent magnet is used to form a uniform magnetic field. The permanent magnet may be but is not limited to a ferrite magnet and a neodymium iron boron magnet. In one example, in order to improve and unify the magnetic field intensity, the permanent magnet is configured as an annular magnet 17. Of course, the permanent magnet may also be formed by a plurality of discrete magnets. Preferably, the plurality of magnets is uniformly distributed around the coil component to ensure that magnetic field forces received by the coil component are balanced. In such a structure, the plurality of magnets has the same polarity. For example, the ends of the plurality of magnets close to the upper shell 11 are all N poles, and the ends of the plurality of magnets close to the lower shell 25 are all S poles.

As shown in FIG. 2 or 3, a first end and a second end which are disposed oppositely are arranged in an axial direction of the permanent magnet. The axial direction is parallel with the vibration direction. A first washer 15 is disposed at the first end. A second washer 19 is disposed at the second end. The first washer 15 and the second washer 19 are used for forming a magnetic shield to concentrate the magnetic lines of the permanent magnet, such that the magnetic field intensity is further improved. In the present invention, the permanent magnet is axially magnetized. The axially magnetizing direction, i.e., the direction of the magnetic lines, is along the axial direction of the permanent magnet. For example, one end of the annular magnet 17 close to the upper shell 11 is the N pole, and one end of the annular magnet 17 close to the lower shell 25 is the S pole. The polarities of the washers are the same as those of the permanent magnet close to them. Thus, it can be known that the polarity of the first washer 15 is the N pole and the polarity of the second washer 19 is the S pole.

The permanent magnet is disposed by surrounding the coil component. A clearance exists between the permanent magnet and the coil component. Preferably, the middle of the permanent magnet along the vibration direction corresponds to a position of the magnetic pole 23. Since the middle of the permanent magnet corresponds to the position of the magnetic pole 23, when the coil component is powered on, an attractive force that the magnetic pole 23 is subjected to from the first washer 15 equals to an attractive force that the magnetic pole 23 is subjected to from the second washer 19. These two attractive forces are equal in size and opposite in direction, and in this way, the vibrator component is balanced in stress.

The elastic element is used to support the vibrator component, such that the vibrator component is suspended in the cavity body. The elastic element is further used to provide an elastic force for the vibrator component. The elastic force is along the vibration direction. The elastic force enables the vibrator component to be returned back to an initial position relative to the stator component, and the elastic force limits a vibration amplitude of the vibrator component to prevent the vibrator component from colliding against the shell.

In the present invention, the elastic element has a third end and a fourth end along the vibration direction. The third end is connected to any one of the top or the bottom. The fourth end is connected to the vibrator component. In one example, the elastic element is a spiral elastic sheet 12. As shown in FIGS. 3 and 5, for example, the spiral elastic sheet 12 is located on one side of the vibrator component close to the top or one side of the vibrator component close to the bottom. If the spiral elastic sheet 12 is located on one side of the vibrator component close to the bottom, a space between the FPCB 20 and the vibrator component can be fully used, such that the linear vibration motor can be made thinner. The spiral elastic sheet 12 has the characteristics of a firm structure, uniform elastic deformation, and the like. The spiral elastic sheet 12 can be connected to the shell and the vibrator component in a manner of welding or adhering. For example, the fourth end of the spiral elastic sheet 12 can be welded onto the tungsten steel block 14. It should be noted that in consideration of a fact that in the welding process, high temperature is possibly adverse to the generation of magnetism of the permanent magnet. During welding, the tungsten steel block 14 and the spiral elastic sheet 12 can be welded at first, and then the tungsten steel block 14 is connected to the permanent magnet. Similarly, the third end of the spiral elastic sheet 12 can be welded onto the top of the upper shell 11.

According to the linear vibration motor provided by the present invention, in a vibration process, except for an elastic force of the elastic element and the Lorentz force of the magnetic fields, the magnetic pole 23 of the pole core 18 is also subjected to an action from a magnetic force of the permanent magnet.

Specifically, as shown in FIG. 2, the linear vibration motor comprises two coils. A case that the first coil 16 has a clockwise current and the second coil 22 has a counterclockwise current (when seen from the top) is taken as an example.

In one aspect, after the coil component is powered on, the first coil 16 is subjected to the action of a downward Lorentz force. Since the first coil 16 is fixed on the lower shell 25 and cannot move, the vibrator component is subjected to a counteractive force to move upwards. Meanwhile, the second coil 22 is subjected to the action of the downward Lorentz force. Since the second coil 22 is fixed on the lower shell 25 and cannot move, the vibrator component is subjected to a counteractive force to move upwards. Thus, it can be seen that the two coils are subjected to the actions of the Lorentz forces in the same direction, such that the counteractive forces that the vibrator component is subjected to are greatly increased, that is, a drive force of the vibrator component is greatly increased. Further, time for the vibrator component to reach a normal vibration amplitude from a static state is shorter, that is, a vibration response speed is faster.

In the other aspect, the two coils sleeve the pole core 18. The first washer 15 is disposed on the upper end of the annular magnet 17. Due to a polarizing action of the annular magnet 17, the polarity of the first washer 15 is the N pole. The second washer 19 is disposed on the lower end of the annular magnet 17. Due to the polarizing action of the annular magnet 17, the polarity of the second washer 19 is the S pole. Since the first coil 16 is formed by clockwise winding, when a current has a clockwise direction (when seen from the top), the lower end of the first coil 16 is the N pole while the upper end thereof is the S pole. Since the second coil 22 is formed by counterclockwise winding, when a current has a counterclockwise direction (when seen from the top), the upper end of the second coil 22 is the N pole while the lower end thereof is the S pole. The lower end of the first coil 16 and the upper end of the second coil 22 are located on the magnetic pole 23 of the pole core 18. The magnetic fields are concentrated by the pole core 18. Besides, the magnetic pole 23 is an overflowing end of magnetic lines, that is, the N pole. Thus it can be seen that the polarity of the magnetic pole 23 is the N pole. Since the first pole 15 is also the N pole, a repulsive force is formed between the magnetic pole 23 and the first washer 15, and a direction of such repulsive force is the same as that of the Lorentz force; as a result, the vibrator moves upwards and a drive force of the coil component is increased. Meanwhile, since the second pole 19 is the S pole, an attractive force is formed between the magnetic pole 23 and the second washer 19, and a direction of such attractive force is the same as that of the Lorentz force; as a result, the vibrator component moves upwards. Thus it can be seen that the magnetic forces between the N pole and the S pole of the annular magnet 17 and the magnetic pole 23 provide the drive force for the vibrator component. Due to the magnetic forces between the magnetic pole 23 and the annular magnet 17 (by the first washer 15 and the second washer 19), the drive force that the vibrator component is subjected to is further increased, that is, the magnetic force enables a response speed of the linear vibration motor to be faster.

In addition, as the magnetic pole 23 is deviated away from an original position, a distance between the first washer 15 and magnetic pole 23 will be shortened, and the attractive force between the two will be further increased. The force between the magnetic pole 23 and the annular magnet 17 (by the first washer 15 and the second washer 19) is similar to a spring force, that is, a “magnetic spring” is formed. The direction of an elastic force of the “magnetic spring” is opposite to that of the elastic force of the spiral elastic sheet 12. It is equivalent to that an elastic coefficient of the spiral elastic sheet 12 is reduced due to the “magnetic spring”. Further f₀ (the lowest resonant frequency) of the linear vibration motor is reduced, the vibration sensitivity is improved, and the vibration sense experience is enhanced. In addition, the strength of an annular elastic sheet can also be improved by increasing a thickness of the annular elastic sheet in a case of keeping f₀ unchanged. Thus, the stability of the linear vibration motor is improved, and a service life of the linear vibration motor is prolonged.

It can be appreciated by those skilled in the art that when the current directions of the first coil 16 and the second coil 22 are changed, that is, the current direction of the first coil 16 is the counterclockwise direction, and the current direction of the second coil 22 is the clockwise direction, the directions in which the vibrator component is subjected to the Lorentz force and is subjected to the force of the “magnetic spring” are opposite to those mentioned above.

In order to further improve a vibration effect of the linear vibration motor, in one preferable embodiment of the present invention, the upper shell 11 and the lower shell 25 are made of a magnetically conductive material. For example, the upper shell 11 and the lower shell 25 are made of iron, cobalt or nickel. The magnetically conductive material is a material that can be easily magnetized by the permanent magnet. In the present embodiment, there exists an attractive force between the upper shell 11 and the annular magnet 17. Besides, when the vibrator component moves upwards, as the distance between the annular magnet 17 and the upper shell 11 is reduced, the attractive force between the two is increased. Therefore, a drive force for the vibrator component to vibrate upwards is further increased. There also exists the attractive force between the lower shell 25 and the annular magnet 17. When the vibrator component moves downwards, as the distance between the annular magnet 17 and the lower shell 25 is reduced, the attractive force between the two is increased. Therefore, a drive force for the vibrator component to vibrate downwards is further increased. When the vibrator component is located in the initial position, the attractive forces that the vibrator component is subjected to from the upper shell 11 and the lower shell 25 are equal in size and opposite in direction.

In addition, the directions of the attractive forces between the upper shell 11 and the annular magnet 17 as well as between the lower shell 25 and the annular magnet 17 are opposite to that of an elastic force of the spiral elastic sheet 12. It is equivalent to that a “magnetic spring” is formed between the upper shell 11 and the lower shell 25 and the annular magnet 17. An elastic coefficient of the spiral elastic sheet 12 is further reduced due to the “magnetic spring”. Thus. the f₀ (the lowest resonant frequency) of the linear vibration motor is reduced, the vibration sensitivity is improved, and the vibration sense experience is enhanced. In addition, the strength of an annular elastic sheet can also be improved by increasing a thickness of the annular elastic sheet in a case of keeping f₀ unchanged. Thus, the stability of the linear vibration motor is improved, and a service life of the linear vibration motor is prolonged.

In order to enable the structure of the vibration motor to be steady, in one example, one end of the pole core 18 is connected to the bottom, and the other end of the pole core 18 is connected to the top. In this way, the pole core 18 plays a role of supporting the shell, such that the structure of the linear vibration motor is more steady.

In order to buffer the vibration of the vibrator component to prevent the vibrator component from colliding against the shell, in one example, a damping part is disposed in a position of the bottom corresponding to the counter weight part (for example, the tungsten steel block 14). The damping part may be but is not limited to rubber, silica gal, sponge or foam. For example, the tungsten steel block 14 can be square. Four sides of the tungsten steel block 14 protrude out of the lower surface. Then the damping part can be, for example, four flaky dampers 21. The flaky dampers 21 are disposed on the lower shell 25 in an adhering manner. The 4 flaky dampers 21 are respectively disposed in positions corresponding to the four corners of the tungsten steel block 14. For example, a flange-shaped annular bulge is formed in a region of the tungsten steel block 14 connected to the permanent magnet. Such an annular bulge is located on the upper surface of the tungsten steel block 14. For example, the damping part is configured as an annular elastic gasket 13, and is disposed on the annular bulge. Of course, the annular elastic gasket can also be disposed in a position of the upper shell 11 corresponding to the annular bulge. The damping part is disposed such that a collision force between the vibrator component and the shell can be effectively buffered, and further the service life of the linear vibration motor can be extended. Besides, the damping part can effectively reduce the noise caused by collision.

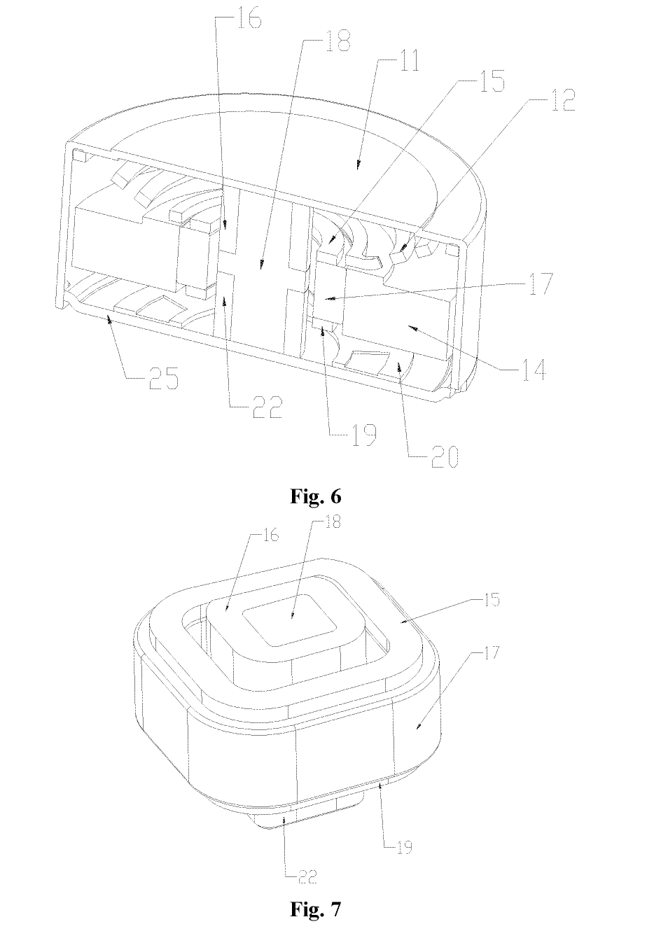

A magnetic path system consists of the coil component, the magnetic core 18, the permanent magnet and washers. The coil component, for example the first coil 16 and the second coil 22, sleeve the outer side of the pole core 18. The permanent magnet, for example, the annular magnet 17 is disposed by surrounding the coil component. A clearance exists between the annular magnet 17 and the coil component. The washers are located on upper and lower ends of the annular magnet 17 along the axial direction, wherein the first washer 15 is located on the upper end and the second washer 19 is located on the lower end. As shown in FIG. 6 or 7, in order to adapt to different mounting environments, the magnetic path system is configured to be square or round. The square structure occupies the same assemble space as the round structure. However, the square structure can enable the vibrator component to have a larger mass, and can effectively improve a vibration amplitude.

Although some specific embodiments of the present invention have been described in detail by way of example, it should be understood by those skilled in the art that the above examples are merely for the sake of description rather than limiting the scope of the present invention. It should be understood by those skilled that the above embodiments may be modified without departing from the scope and spirit of the present invention. The scope of the present invention is limited by the appended claims.

1-10. (canceled)

11. A linear vibration motor, comprising:
a stator component, the stator component comprising a shell, a pole core and a coil component, wherein the shell has a cavity body therein, the shell comprises a top and a bottom opposite to the top, the pole core and the coil component are located in the cavity body, the pole core is disposed on the bottom, the pole core comprises a magnetic pole located in the middle of the pole core along a vibration direction and protruding out of the outer surface of the pole core, the coil component sleeves the outer surface of the pole core, the coil component is divided into a first coil and a second coil by the magnetic pole, and a current direction of the first coil is opposite to that of the second coil;
a vibrator component, wherein the vibrator component comprises a permanent magnet disposed by surrounding the coil component and a counter weight part disposed on the permanent magnet, wherein the permanent magnet is axially magnetized, and after the coil component is powered on, a magnetic force is formed between the magnetic pole and the permanent magnet; and
an elastic element, wherein the vibrator component is suspended in the cavity body by the elastic element, and the elastic element is configured for returning the vibrator component to an initial position.

12. The linear vibration motor according to claim 11, wherein:
the shell comprises an upper shell and a lower shell which are connected together,
the top is located on the upper shell, and
the bottom is located on the lower shell.

13. The linear vibration motor according to claim 12, wherein:
one end of the pole core and the bottom are connected together, and
the other end of the pole core and the top are connected together.

14. The linear vibration motor according to claim 11, wherein:
the elastic element is a spiral elastic sheet, and
the spiral elastic sheet is located on one side of the vibrator component close to the top.

15. The linear vibration motor according to claim 12, wherein the upper shell and the lower shell are made of a magnetically conductive material.

16. The linear vibration motor according to claim 12, wherein a material of the upper shell and the lower shell is at least one of iron, cobalt or nickel.

17. The linear vibration motor according to claim 11, wherein at least one of a position of the bottom corresponding to the counter weight part and a position of the top corresponding to the counter weight part is provided with a damping part.

18. The linear vibration motor according to claim 11, further comprising a magnetic path system that comprises the coil component, the pole core, the permanent magnet and washers, the coil component sleeves the outer side of the pole core, the permanent magnet is disposed by surrounding the coil component, a clearance exists between the permanent magnet and the coil component, the washers are located on upper and lower ends of the permanent magnet, and the magnetic path system is configured to be square or round.

19. The linear vibration motor according to claim 11, wherein:
a first end and a second end which are disposed oppositely are arranged in an axial direction of the permanent magnet,
a first washer is disposed at the first end, and
a second washer is disposed at the second end.

20. The linear vibration motor according to claim 11, wherein a flexible printed circuit board (FPCB) is provided on the bottom, the coil component is electrically connected to an external circuit through the FPCB, and the counter weight part is further provided with a makeway groove for making room for the FPCB.

21. The linear vibration motor according to claim 11, wherein:
the elastic element is a spiral elastic sheet, and
the spiral elastic sheet is located on one side of the vibrator component close to the bottom.
